(19) United States
(12) Patent Application Publication
(10) Pub. No.: US 2007/0226177 A1
(43) Pub. Date: Sep. 27, 2007

(54) Evaluating a current partitioning of a database

(75) Inventors: Eric L. Barsness, Pine Island, MN (US); John M. Santosuosso, Rochester, MN (US)

Correspondence Address: IBM (ROC-BLF), C/O BIGGERS & OHANIAN, LLP, P.O. BOX 1469, AUSTIN, TX, 78767-1469, US

(73) Assignee: INTERNATIONAL BUSINESS MACHINES CORPORATION, ARMONK, NY (US)

(21) Appl. No.: 11/388,009

(22) Filed: Mar. 23, 2006

(51) Int. Cl. G06F 17/30

(52) U.S. Cl. 707/2

(57) ABSTRACT

Methods, apparatus, and products for evaluating a current partitioning of a database are disclosed that include querying each database partition of the database with an identical query statement, measuring performance of each database partition query, and identifying database partition characteristics of the current partitioning of the database in dependence upon the measured performance.

### BACKGROUND OF THE INVENTION

1. Field of the Invention

The field of the invention is data processing, or, more specifically, methods, systems, and products for evaluating a current partitioning of a database.

2. Description Of Related Art

The development of the EDVAC computer system of 1948 is often cited as the beginning of the computer era. Since that time, computer systems have evolved into extremely complicated devices. Today's computers are much more sophisticated than early systems such as the EDVAC. Computer systems typically include a combination of hardware and software components, application programs, operating systems, processors, buses, memory, input/output devices, and so on. As advances in semiconductor processing and computer architecture push the performance of the computer higher and higher, more sophisticated computer software has evolved to take advantage of the higher performance of the hardware, resulting in computer systems today that are much more powerful than just a few years ago.

As computer software has become more sophisticated, the data processing and data collection capabilities of computer systems have increased. Computer software architects often design large databases to store the collected data. The largest databases are partitioned databases that distribute data across multiple database partitions. One or more database partitions may exist on a single computer node, but typically each computer node contains only one database partition. Partitioning a database provides improved overall data processing performance because each partition operates in parallel with the other partitions of the database.

To access the data collected in a database, client applications query the database using a query statement. A query statement specifies a result to be calculated by the database and to be returned to the client application querying the database. In a partitioned database, a query requesting data distributed across multiple database partitions runs on each database partition and each database partition supplies a portion of the query statement result. Queries requesting data distributed across multiple database partitions therefore return results no faster than the response time of the slowest database partition.

Because having similar response times from each database partition enhances data retrieval performance, computer software architects typically distribute the data evenly across the multiple partitions of a database. Often, however, partitioning a database to distribute data evenly across all of the database partition causes some database partitions to return results of a query statement more slowly than other database partitions. The disparity in response time in such a partitioning of a database may result from a database partition that exists on a slower computer node than the other database partitions. The disparity in response time may also result from having less computer resources of a computer node allocated to a database partition than the other database partitions. Partitioning a database to distribute data evenly across multiple partitions in such a computer hardware environment results in a degradation of data retrieval performance.

### SUMMARY OF THE INVENTION

Methods, apparatus, and products for evaluating a current partitioning of a database are disclosed that include querying each database partition of the database with an identical query statement, measuring performance of each database partition query, and identifying database partition characteristics of the current partitioning of the database in dependence upon the measured performance.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a network diagram illustrating an exemplary system for evaluating a current partitioning of a database according to embodiments of the present invention.

FIG. 2 sets forth a block diagram of automated computing machinery comprising an exemplary computer useful in evaluating a current partitioning of a database according to embodiments of the present invention.

FIG. 3 sets forth a flow chart illustrating an exemplary method for evaluating a current partitioning of a database according to embodiments of the present invention.

FIG. 4 sets forth a flow chart illustrating a further exemplary method for evaluating a current partitioning of a database according to embodiments of the present invention.

FIG. 5 sets forth a flow chart illustrating a further exemplary method for evaluating a current partitioning of a database according to embodiments of the present invention.

FIG. 6 sets forth a flow chart illustrating a further exemplary method for evaluating a current partitioning of a database according to embodiments of the present invention.

### DETAILED DESCRIPTION OF EXEMPLARY EMBODIMENTS

### Detailed Description

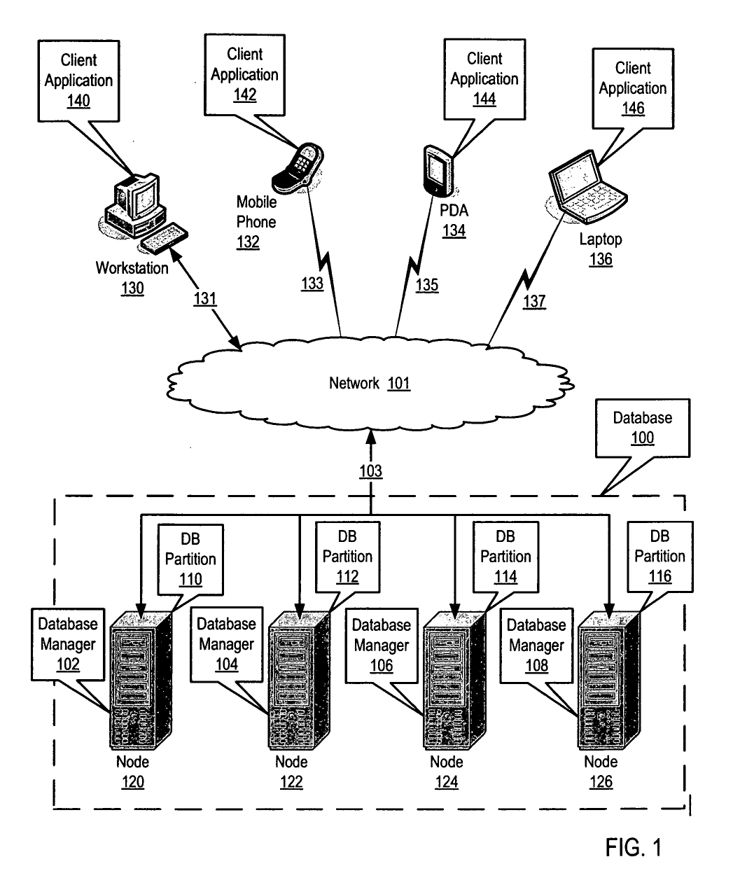

Exemplary methods, apparatus, and products for evaluating a current partitioning of a database according to embodiments of the present invention are described with reference to the accompanying drawings, beginning with FIG. 1. FIG. 1 sets forth a network diagram illustrating an exemplary system for evaluating a current partitioning of a database according to embodiments of the present invention. The system of FIG. 1 operates generally to evaluate a current partitioning of a database according to embodiments of the present invention by querying each database partition of the database with an identical query statement, measuring performance of each database partition query, and identifying database partition characteristics of the current partitioning of the database in dependence upon the measured performance.

The example system of FIG. 1 includes nodes (120-126) connected to network (101) through a wireline connection (103). Nodes (120-126) in the system of FIG. 1 collectively operate to support a partitioned database (100). A database is an organized collection of data. A database typically organizes the data of a database into data elements, also called ‘columns’ or ‘fields,’ that are associated together to form records. These records are also referred to as ‘rows.’ A database typically organizes records into tables that are stored as files on a node. In addition, a database also includes indexes, configuration files, transaction logs, and so on. The database (100) in the example of FIG. 1 is a database composed of multiple database partitions (110-116) collectively referred to as a ‘database partition group.’ A database partition is a part of a database that consists of its own data, indexes, configuration files, and transaction logs installed on the database partition. Partitioning a database refers to dividing a database across multiple database partitions. Each table of a partitioned database may be located in one or more database partitions. When a table is located across multiple database partitions, some of the rows of the table are stored in one database partition, while other rows of the table are stored in other database partitions.

A database partition exists on a hardware partition. A hardware partition is a subset of data processing system hardware resources. Readers will note that although the example of FIG. 1 depicts each database partition on a separate hardware partition, such a depiction is for explanation and not for limitation. In fact, multiple database partitions may exist on the same hardware partition in evaluating a current partitioning of a database according to embodiments of the present invention.

Database administrators may partition the data of a database by declaring a particular data element in a record as a partitioning key and mapping a record of data to a database partition in dependence upon the value of the partitioning key in the particular record. A partition map stores the mapping between a particular value of a partitioning key and particular database partition. Typical criteria for mapping particular values of a partitioning key to database partitions include list partitioning, range partitioning, and hash partitioning. List partitioning includes assigning a value of the partitioning key to a particular database partition. For example, if the partitioning key to a particular database partition is the ‘state’ field of a table, the values ‘Texas,’ ‘Louisiana,’ and ‘Mississippi’ for the partitioning key may be assigned to a database partition identified as ‘partition 5.’

Range partitioning includes assigning a range of values for the partitioning key to a particular database partition. For example, if the partitioning key is the ‘area code’ field of a table, the range of values from ‘500’ to ‘599’ for the partition key may be assigned to a database partition identified as ‘partition 3.’

Hash partitioning includes assigning an output value of a hash function to a particular database partition. The output value of the hash function depends on the value of the partitioning key provided as input to the hash function. For example, a hash function may return a value between the range of 0 and 7. The output values of the hash function map to particular database partitions. For example, the outputs ‘0’ and ‘3’ of a hash function may map to a database partition labeled ‘partition 1’ and the outputs ‘1’ and ‘4’ of a hash function may map to a database partition labeled ‘partition 2.’

In the system of FIG. 1, each node (120-126) has installed upon it a database partition (110-116) of database (100). Client applications interact with the database (100) through a single database partition, known as the coordinator partition for that particular client application. Because each client application may connect to the database (100) through a different database partition, each client application may have a different coordinator partition. In the example of FIG. 1, any database partition (110-116) of the database (100) may operate as a coordinator partition. The coordinator partition is the database partition running the database manager through which the client application connects to the database (100).

In the system of FIG. 1, each node (120-126) also has installed upon it a database manager (102-108). Each database manager (102-108) is a set of computer program instructions for managing a database partition (110-116). In the example of FIG. 1, the database managers (102-108) use the hardware resources of each node (120-126) to manage each database partition's portion of the total data in the database (100). The database managers (102-108) communicate with client applications for transaction processing, provide compiling for query statements, communicate with other database managers in a database, and maintain the overhead associated with transaction processing such as, for example, partitioning, indexing, configuration, transaction logs, and so on.

In the example of FIG. 1, the database manager (102) also includes a set of computer program instructions improved for evaluating a current partitioning of a database according to embodiments of the present invention. The database manager (102) operates generally for evaluating a current partitioning of a database (100) by querying each database partition of the database with an identical query statement, measuring performance of each database partition query, and identifying database partition characteristics of the current partitioning of the database in dependence upon the measured performance.

The system of FIG. 1 also includes a number of devices (130, 132, 134, 136) having installed upon them client applications (140-146) for requesting transaction processing from database (100). Each device (130, 132, 134, 136) connects for data communications to network (101). Workstation (130) connects to network (101) through a wireline connection (131). Network-enable mobile phone (132) connects to network (101) through a wireless connection (133). Personal Digital Assistant (‘PDA’) connects to network (101) through a wireless connection (135). Laptop (136) connects to network (101) through a wireless connection (137). When a database manager operating on a coordinating partition for a client application (140-146) receives a transaction processing request from a client application (140-146), the database manager communicating with the particular client application (140-146) distributes the request to database managers operating on the other database partitions of the database (100). All the database managers process the transaction processing request and return the result to the database manager operating on the coordinating partition for the particular client application requesting transaction processing. The database manager operating on the coordinating partition then returns the result of the transaction processing request to the client application.

Because a client application only issues a transaction processing request to one of the database managers in the database (100), the partitioning of the database (100) is transparent to each client application (140-146) requesting transaction processing. In the example of FIG. 1, a client application (140-146) may communicate with a database manager (102-108) using a database access application programming interface (‘API’). Database access APIs useful in evaluating a current partitioning of a database according to embodiments of the present invention may include, for example, the Open Database Connectivity (‘ODBC’) API, the Object Linking and Embedding for Databases (‘OLE DB’) API, the Java Database Connectivity (‘JDBC’) API, and so on.

The arrangement of servers and other devices making up the exemplary system illustrated in FIG. 1 are for explanation, not for limitation. Data processing systems useful according to various embodiments of the present invention may include additional servers, routers, other devices, and peer-to-peer architectures, not shown in FIG. 1, as will occur to those of skill in the art. Networks in such data processing systems may support many data communications protocols, including for example TCP (Transmission Control Protocol), IP (Internet Protocol), HTTP (HyperText Transfer Protocol), WAP (Wireless Access Protocol), HDTP (Handheld Device Transport Protocol), and others as will occur to those of skill in the art. Various embodiments of the present invention may be implemented on a variety of hardware platforms in addition to those illustrated in FIG. 1.

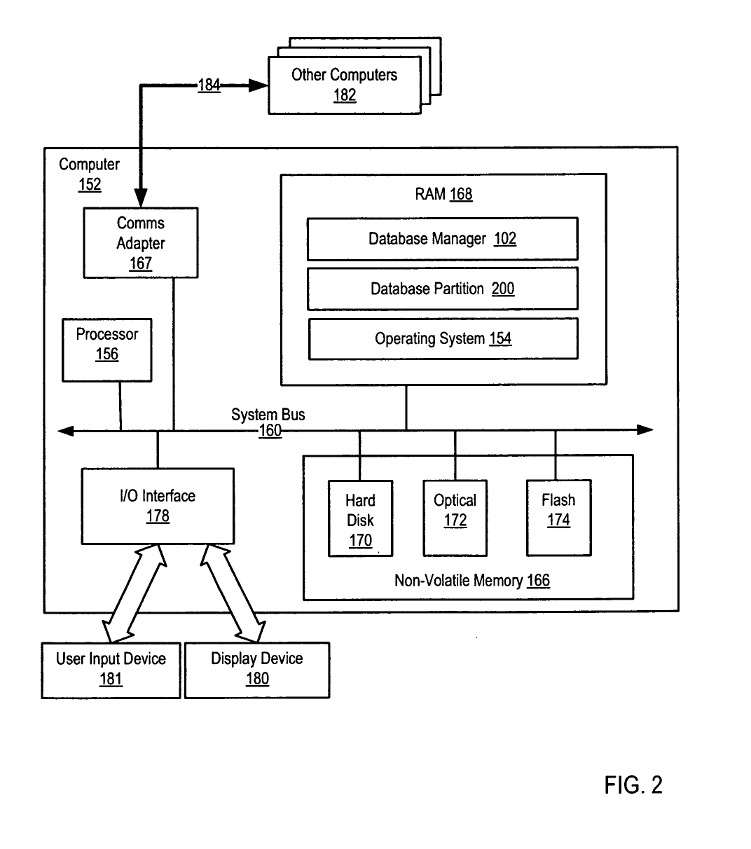

Evaluating a current partitioning of a database in accordance with the present invention is generally implemented with computers, that is, with automated computing machinery. In the system of FIG. 1, for example, all the nodes, servers, and communications devices are implemented to some extent at least as computers. For further explanation, therefore, FIG. 2 sets forth a block diagram of automated computing machinery comprising an exemplary computer (152) useful in evaluating a current partitioning of a database according to embodiments of the present invention. The computer (152) of FIG. 2 includes at least one computer processor (156) or ‘CPU’ as well as random access memory (168) (‘RAM’) which is connected through a system bus (160) to processor (156) and to other components of the computer.

Stored in RAM (168) is a database manager (102) that manages database partition (200). The database manager (102) is a set of computer program instructions improved for evaluating a current partitioning of a database according to embodiments of the present invention. In the example of FIG. 2, the database manager (102) operates generally for evaluating a current partitioning of a database by querying each database partition of the database with an identical query statement, measuring performance of each database partition query, and identifying database partition characteristics of the current partitioning of the database in dependence upon the measured performance. The database manager (102) also operates generally for evaluating a current partitioning of a database by selecting the identical query statement from a historical list of query statements for querying the database. The database manager (102) also operates generally for evaluating a current partitioning of a database by identifying a new partitioning of the database in dependence upon the database partition characteristics. The database manager (102) also operates generally for evaluating a current partitioning of a database by modifying at least one database partition of the database in dependence upon the database partition characteristics and moving data from at least one database partition of the database to at least one other database partition of the database in dependence upon the database partition characteristics. The database manager (102) also operates generally for evaluating a current partitioning of a database by reporting the database partition characteristics. The database manager (102) also operates generally for evaluating a current partitioning of a database by measuring the response time of each database partition query.

Also stored in RAM (168) is an operating system (154). Operating systems useful in computers according to embodiments of the present invention include UNIX™, Linux™, Microsoft XP™, AIX™, IBM's i5/OS™, and others as will occur to those of skill in the art. Operating system (154), the database manager (102), and database partition (200) in the example of FIG. 2 are shown in RAM (168), but many components of such software typically are stored in non-volatile memory (166) also.

Computer (152) of FIG. 2 includes non-volatile computer memory (166) coupled through a system bus (160) to processor (156) and to other components of the computer (152). Non-volatile computer memory (166) may be implemented as a hard disk drive (170), optical disk drive (172), electrically erasable programmable read-only memory space (so-called ‘EEPROM’ or ‘Flash’ memory) (174), RAM drives (not shown), or as any other kind of computer memory as will occur to those of skill in the art.

The example computer of FIG. 2 includes one or more input/output interface adapters (178). Input/output interface adapters in computers implement user-oriented input/output through, for example, software drivers and computer hardware for controlling output to display devices (180) such as computer display screens, as well as user input from user input devices (181) such as keyboards and mice.

The exemplary computer (152) of FIG. 2 includes a communications adapter (167) for implementing data communications (184) with other computers (182). Such data communications may be carried out serially through RS-232 connections, through external buses such as the Universal Serial Bus (‘USB’), through data communications networks such as IP networks, and in other ways as will occur to those of skill in the art. Communications adapters implement the hardware level of data communications through which one computer sends data communications to another computer, directly or through a network. Examples of communications adapters useful for determining availability of a destination according to embodiments of the present invention include modems for wired dial-up communications, Ethernet (IEEE 802.3) adapters for wired network communications, and 802.11b adapters for wireless network communications.

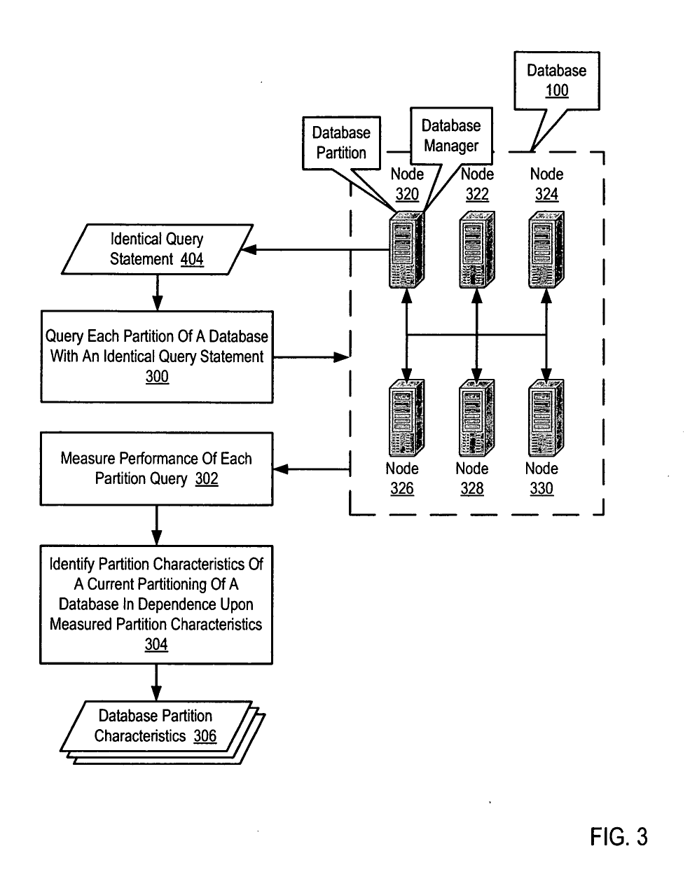

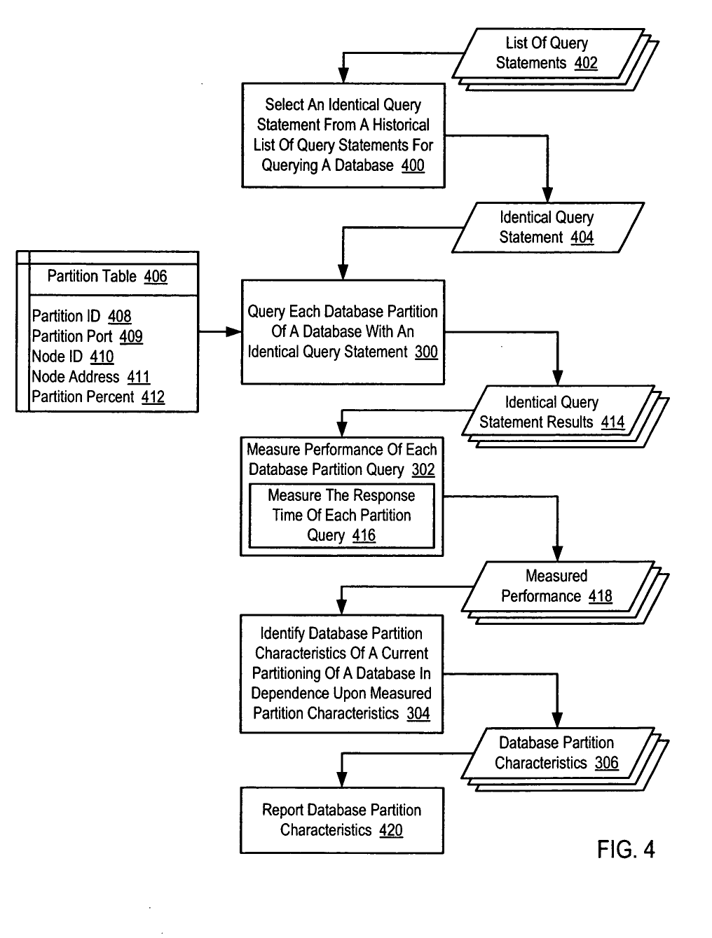

For further explanation, FIG. 3 sets forth a flow chart illustrating an exemplary method for evaluating a current partitioning of a database (100) according to embodiments of the present invention. In the example of FIG. 3, database (100) includes nodes (320-330), each node (320-330) having installed upon it a database partition and a database manager as described above with reference to FIG. 1. The method in the example of FIG. 3 includes querying (300) each database partition of the database with an identical query statement (404). The identical query statement (404) represents the result to be calculated by each database partition of a database for evaluating the current partitioning of the database. In the example of FIG. 3, the database manager installed on node (320) provides the identical query statement (404) for querying (300) each database partition of the database with an identical query statement (404). Querying (300) each database partition of the database with an identical query statement (404) may be carried out as discussed below with reference to FIG. 4.

The method in the example of FIG. 3 also includes measuring (302) performance of each database partition query. The measured performance represents characteristics of querying a database partition of a database with an identical query statement (404). Such measured characteristics are useful in evaluating the current partitioning of the database. Measuring (302) performance of each database partition query may be carried out as discussed below with reference to FIG. 4.

The method in the example of FIG. 3 also includes identifying (304) database partition characteristics (306) of the current partitioning of the database in dependence upon the measured performance. Database partition characteristics (306) represent characteristics of the current partitioning of a database. Identifying (304) database partition characteristics of the current partitioning of the database in dependence upon the measured performance may be carried out as described below with reference to FIG. 4.

As discussed above, evaluating a current partitioning for a database includes querying each database partition of the database with an identical query statement, measuring performance of each database partition query, identifying database partition characteristics of the current partitioning of the database in dependence upon the measured performance. Evaluating a current partitioning for a database according to embodiments of the present invention may also include selecting the identical query statement from a historical list of query statements for querying the database. For further explanation, therefore, FIG. 4 sets forth a flow chart illustrating a further exemplary method for evaluating a current partitioning of a database according to embodiments of the present invention. The method of FIG. 4 includes selecting (400) the identical query statement (404) from a historical list of query statements (402) for querying the database, querying (300) each database partition of the database with an identical query statement (404), measuring (302) performance of each database partition query, identifying (304) database partition characteristics (306) of the current partitioning of the database in dependence upon the measured performance (418), and reporting (420) the database partition characteristics (306).

The method of FIG. 4 begins with selecting (400) the identical query statement (404) from a historical list of query statements (402) for querying the database. A query statement is a specification of a result to be calculated from a database. A query statement is specified using a query language such as, for example, the Structured Query Language (‘SQL’), the XML Query Language (‘XQuery’), the QUEry Language (‘QUEL’), and so on. An example of a SQL query statement may include “SELECT*FROM sales,” which specifies all the data stored in the ‘sales’ table as the result to be calculated by the database and returned to the application providing the query statement. In the example of FIG. 4, the identical query statement (404) represents the result to be calculated by each database partition of a database for evaluating the current partitioning of the database. The historical list of query statements (402) represents all results calculated by the database prior to selecting (400) the identical query statement. A database may store the historical list of query statements (402) in a log file or a table along with attributes of each historical query statement such as, for example, the frequency with which the database calculates the result specified in the statement, the time and date of the most recent occurrence of the historical query statement, the particular client application specifying the historical query statement, and so on. A query analysis tool such as, for example, the IBM® DB2 Query Governor, may provide the historical list of query statements (402) and associated attributes.

In the method of FIG. 4, selecting (400) the identical query statement (404) from a historical list of query statements (402) for querying the database may be carried out by selecting as the identical query statement (404) the historical query statement from the historical list of query statements (402) that occurs most frequently. Selecting (400) the identical query statement (404) from a historical list of query statements (402) for querying the database according to the method of FIG. 4 may also be carried out by selecting as the identical query statement (404) the historical query statement from the historical list of query statements (402) that occurred most recently as the identical query statement (404). Selecting (400) the identical query statement (404) from a historical list of query statements (402) for querying the database according to the method of FIG. 4 may also be carried out by selecting as the identical query statement (404) the historical query statement specified by a particular client application as the identical query statement (404). Selecting (400) the identical query statement (404) from a historical list of query statements (402) for querying the database according to the method of FIG. 4 may also be carried out by selecting as the identical query statement (404) the historical query statement processed by the database at a specific time of day as the identical query statement (404). Selecting (400) the identical query statement (404) from a historical list of query statements (402) for querying the database as described above with reference to FIG. 4 is for explanation and not for limitation. In fact, selecting (400) the identical query statement (404) from a historical list of query statements (402) for querying the database may be carried out in dependence upon other criteria as will occur to those of skill in the art.

In the method of FIG. 4, querying (300) each database partition of the database with an identical query statement (404) may be carried out by transmitting the identical query statement (404) to each database partition of the database through a data communications connection such as, for example, a TCP/IP connection. The term ‘TCP’ stands for ‘Transmission Control Protocol.’ In TCP parlance, the endpoint of a data communications connection is a data structure called a ‘socket.’ Two sockets form a data communications connection, and each socket includes a port number and a network address for the respective data connection endpoint. Using a partition port (409) and a node address (411) from a partition table (406), transmitting the identical query statement (404) to each database partition of the database may be implemented by transmitting the identical query statement (404) from a socket identifying a database manager operating in one database partition to a socket identifying a database manager operating in another database partition. In the method of FIG. 4, implementing the data communications connection with a TCP/IP connection, however, is for explanation and not for limitation. Transmitting the identical query statement (404) to each database partition of the database through a data communications connection may be implemented using other data communication protocols such as, for example, the Internet Packet Exchange (‘IPX’) and Sequenced Packet Exchange (‘SPX’) network protocols.

The example of FIG. 4 includes a partition table (406) that stores database partition configuration information for each database partition of the database. An example of a partition table useful for evaluating a current partitioning of a database according to embodiments of the present invention may include the ‘db2nodes.cfg’ file used in the IBM® DB2 Universal Database for storing partition configuration information. In the example of FIG. 4, the partition table (406) associates a partition identifier (408) with a partition port (409), a node identifier (410), a node address (411), and a partition percent (412). The partition identifier (408) represents a database partition resulting from the current partitioning of the database. The partition port (409) represents port address for the database manager that manages the database partition identified by the partition identifier (408). The node identifier (410) represents a computer node whose hardware resources are allocated to a database partition identified by the partition identifier (408). The node address (411) represents a network address on a network of the node identified by the node identifier (410). The partition percent (412) represents the percentage of the total data of the database that is stored in a database partition identified by the partition identifier (408). Although the example of FIG. 4 depicts the node identifier (410) and node address (411) in the partition table (406), such a depiction is for explanation. Readers will note that the node identifier (410) and node address (411) typically exist in a separate node table (not shown) with other attributes describing each node.

When each database partition receives the identical query statement (404), querying (300) each database partition of the database with an identical query statement (404) according to the method of FIG. 4 may continue by calculating on each database partition the results specified in the identical query statement (404). Calculating on each database partition the results specified in the identical query statement (404) may be carried out by compiling the identical query statement (404) on each database partition, executing the compiled identical query statement (404) on each database partition, and storing the results (414) of the identical query statement (404) executed on each database partition in computer memory allocated to the database partition. Compiling the identical query statement (404) may be carried out using a query statement compiler of a database manager. A query statement compiler is computer program instructions for translating query language used to specify the query statement into executable machine code. Executing the compiled identical query statement (404) may be carried out using the computer hardware resources of a node allocated to a database partition.

Querying (300) each database partition of the database with an identical query statement (404) according to the method of FIG. 4 provides a common metric between database partitions for evaluating the current partitioning of the database according to embodiments of the present invention. The method of FIG. 4 therefore continues by measuring (302) performance of each database partition query. Measuring (302) performance of each database partition query according to the method of FIG. 4 includes measuring (416) the response time of each database partition query. Measuring (416) the response time of each database partition query may be carried out by storing a timestamp before and after calculating on each database partition the results specified in the identical query statement (404). Measuring (416) the response time of each database partition query may then continue by subtracting the difference between the timestamp before and after calculating on each database partition the results specified in the identical query statement (404). Storing a timestamp may be carried out using a function call to an operating system API such as, for example, Win32's ‘QueryPerformaceCounter( )’ and ‘QueryPerformanceFrequency( )’ functions, and UNIX's ‘gettimeofday( )’ function.

Although measuring (302) performance of each database partition query according to the method of FIG. 4 includes measuring (416) the response time of each database partition query, measuring (302) performance of each database partition query may also include measuring other characteristics of each database partition query. Other characteristics of each database partition query may include, for example, the CPU utilization of each database partition query, the number of input/output access of each database partition query, the memory utilization of each database partition query, and so on. Measuring other characteristics of each database partition query may be carried out by executing performance traces on each database partition while querying each database partition of a database with an identical query statement (404). Examples of performance traces useful for evaluating a current partition of a database according to embodiments of the present invention may include an accounting trace or a performance trace implemented using the IBM® DB2 Universal Database™. An accounting trace may provide information relating to the CPU and elapsed time of each database partition query, while the performance trace may provide the text of the query statement and a complete trace of the execution of the query statement along with associated statistics of executing the query statement.

The method of FIG. 4 also includes identifying (304) database partition characteristics (306) of the current partitioning of the database in dependence upon the measured performance (418). The measured performance (418) represents characteristics of querying a database partition of a database with an identical query statement (404). The measured performance (418) may include, for example, the response time of querying a database partition of a database with an identical query statement (404), the CPU utilized when querying a database partition of a database with an identical query statement (404), the number of input/output access required when querying a database partition of a database with an identical query statement (404), the computer memory utilized when querying a database partition of a database with an identical query statement (404), and so on.

In the example of FIG. 4, database partition characteristics (306) represent characteristics of a database partition of a database. Database partition characteristics (306) may include, for example, rank ordering of the database partitions based on measured performance (418) such that each database partition is associated with a partition characteristic having a value of ‘1,’ ‘2,’ ‘3,’ and so on. Database partition characteristics (306) may also include, for example, indications of whether a performance problem exists on a database partition. For example, after evaluating a current partitioning of a database according to embodiments of the present invention, a partition characteristic for a particular database partition may indicate that the particular database partition responds more slowly to a query than the other database partitions of the database using a Boolean flag. Database partition characteristics (306) may also include, for example, the average values of the measured performance (418) of each database partition query or the data retrieval rates for each database partition calculated from the measured performance (418) representing the response time of a database partition query and the quantity of data returned by each database partition query.

In the method of FIG. 4, identifying (304) database partition characteristics (306) of the current partitioning of the database in dependence upon the measured performance (418) may be carried out by receiving the measured performance (418) from each database partition through a data communications connection, comparing the measured performance (418) received from each of the database partitions, and assigning a partition characteristic to a database partition in dependence upon the comparison. Receiving the measured performance (418) from each database partition through a data communications connection may be implemented using a TCP/IP connection. Through a TCP/IP connection, a database manager operating on one of the database partition may receive the measured performance (418) from each of the other database managers operating on the other database partitions of the database. Comparing the measured performance (418) received from each of the database partitions may be carried out by identifying outlying values for the measured performance (418) received from each database partition. Consider, for example, that the measured performance (418) represents response time for a query using the identical query statement (404), and that all of the database partitions have a value for the measured performance (418) of fifteen milliseconds except for one database partition that has a value for the measured performance (418) of sixty milliseconds. Comparing the measured performance (418) received from each of the database partitions identifies that the database partition having a value for the measured performance (418) of sixty milliseconds as having an outlying value compared to the other database partitions.

Assigning a database partition characteristic (306) to a database partition in dependence upon the comparison may be carried out by setting a Boolean flag that identifies that the database partition with the longer response time as having an outlying value compared to the other database partitions. A database administrator may use the Boolean flag as an indication that the current partitioning of a database may need a modification.

The method of FIG. 4 also includes reporting (420) the database partition characteristics (306). Reporting (420) the database partition characteristics (306) may be carried out by displaying representations of the database partition characteristics (306) to a database administrator using a graphical user interface (‘GUI’), printing representations of the database partition characteristics (306) in report, storing representations of the database partition characteristics (306) to non-volatile computer memory, and so on.

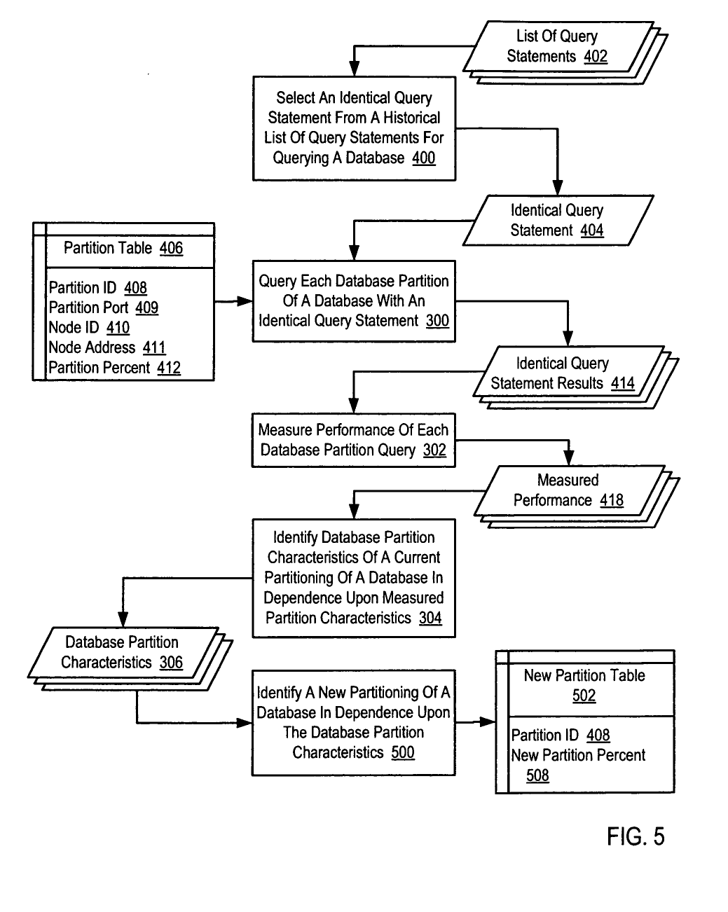

Readers will notice that the method set forth in FIG. 4 evaluates a current partitioning of a database by identifying and reporting the database partition characteristics for each database partition of a database. Evaluating a current partitioning of a database according to embodiments of the present invention may also operate to identify a new partitioning of the database in dependence upon the database partition characteristics. For further explanation, FIG. 5 sets forth a flow chart illustrating a further exemplary method for evaluating a current partitioning of a database according to embodiments of the present invention. The method of FIG. 5 includes selecting (400) the identical query statement (404) from a historical list of query statements (402) for querying the database, querying (300) each database partition of the database with an identical query statement (404), measuring (302) performance of each database partition query, identifying (304) database partition characteristics (306) of the current partitioning of the database in dependence upon the measured performance (418), and identifying (500) a new partitioning of the database in dependence upon the database partition characteristics (306).

The method of FIG. 5 begins with selecting (400) the identical query statement (404) from a historical list of query statements (402) for querying the database. The historical list of query statements (402) represents all results calculated by the database prior to selecting (400) the identical query statement. Selecting (400) the identical query statement (404) from a historical list of query statements (402) for querying the database may be carried out as described above with reference to FIG. 4.

The method of FIG. 5 includes querying (300) each database partition of the database with an identical query statement (404). The identical query statement (404) represents the result to be calculated by each database partition of a database for evaluating the current partitioning of the database. Querying (300) each database partition of the database with an identical query statement (404) according to the example of FIG. 5 may be carried out as described above with reference to FIG. 4 and storing the result (414) of each database partition query in computer memory.

The example of FIG. 5 also includes a partition table (406) that associates a partition identifier (408) with a partition port (409), a node identifier (410), a node address (411), and a partition percent (412). The partition identifier (408) represents a database partition resulting from the current partitioning of the database. The partition port (409) represents port address for the database manager that manages the database partition identified by the partition identifier (408). The node identifier (410) represents a computer node whose hardware resources are allocated to a database partition identified by the partition identifier (408). The node address (411) represents a network address on a network of the node identified by the node identifier (410). The partition percent (412) represents the percentage of the total data stored in the database that is stored in a database partition identified by the partition identifier (408).

The method of FIG. 5 includes measuring (302) performance of each database partition query. The measured performance (418) represents characteristics of querying a database partition of a database with an identical query statement (404). Measuring (302) performance of each database partition query may be carried out as described above with reference to FIG. 4.

The method of FIG. 5 includes identifying (304) database partition characteristics (306) of the current partitioning of the database in dependence upon the measured performance (418). Database partition characteristics (306) represent characteristics of a database partition of a database. Identifying (304) database partition characteristics (306) of the current partitioning of the database in dependence upon the measured performance (418) may be carried out as described above with reference to FIG. 4.

The method of FIG. 5 also includes identifying (500) a new partitioning of the database in dependence upon the database partition characteristics (306). Identifying (500) a new partitioning of the database in dependence upon the database partition characteristics (306) may be carried out by calculating the new partition percent (508) for each database partition in the database. The new partition percent (508) represents the percentage of the total data stored in the database to be stored in a database partition identified by the partition identifier (408) in dependence upon the database partition characteristics (306).

Because database partition characteristics (306) may represent a variety of characteristics for a database partition, identifying (500) a new partitioning of the database in dependence upon the database partition characteristics (306) may depend on the type of database partition characteristics represented by database partition characteristics (306). For further explanation, consider a database having three database partitions labeled ‘partion1,’ ‘partition2,’ and ‘partition3’ with 300 megabytes of data evenly distributed across the database partitions, where the database partition characteristics (306) represent the data transfer rate of each partition, and where ‘partion1’ has data transfer rate of 10 megabytes per second, ‘partion2’ has data transfer rate of 10 megabytes per second, and ‘partion3’ has data transfer rate of 2.5 megabytes per second. The response time for each database partition in the current partitioning of this exemplary database when all the data of the database is queried is calculated as the quantity of data returned from querying each database partition divided by the data retrieval rate of the database partition. The response time for each database partition in the current partitioning of this exemplary database may therefore be calculated as follows:
T₁=D₁R₁=100 megabytes÷10 megabytes per second=10 seconds partition1
T₂=D₂R₂=100 megabytes÷10 megabytes per second=10 seconds partition2
T₃=D₃R₃=100 megabytes÷2.5 megabytes per second=40 seconds partition3

where ‘T_{N}’ is the response time for N^{th} database partition, ‘D_{N}’ is the quantity of data returned from querying the N^{th} database partition, and ‘R_{N}’ is the data retrieval rate of the N^{th} database partition. Although each database partition in this exemplary database operates in parallel, the current partitioning requires a minimum of forty seconds to receive the entire result of the query.

Using the previous example, identifying (500) a new partitioning of the database in dependence upon the database partition characteristics (306) may be carried out by calculating the quantity of data to be stored on each database partition that yields the same response time from each database partition and then calculating the percentage of the new partition percent (508) for each database partition according the quantity of data to be stored on each database partition. Calculating the quantity of data to be stored on each database partition that yields the same response time from each database partition may be carried out by multiplying the data retrieval rate for each database partition by the total quantity of data returned from querying each database partition divided by the sum of the data retrieval rates for all the database partitions. The quantity of data to be stored on each database partition that yields the same response time from each database partition may therefore be calculated as follows:
Q₁=R₁×D_{T}÷(R₁+R₂+R₃)=10 megabytes per second×300 megabytes÷(10 megabytes per second+10 megabytes per second+2.5 megabytes per second)=133.33 megabytes partition1
Q₂=R₂×D_{T}÷(R₁+R₂+R₃)=10 megabytes per second×300 megabytes÷(10 megabytes per second+10 megabytes per second+2.5 megabytes per second)=133.33 megabytes partition2
Q₃=R₃×D÷(R₁+R₂+R₃)=2.5 megabytes per second×300 megabytes÷(10 megabytes per second+10 megabytes per second+2.5 megabytes per second)=33.33 megabytes partition3

where ‘Q_{N}’ is the quantity of data to be stored on the N^{th} database partition, ‘R_{N}’ is the data retrieval rate of the N^{th} database partition, and ‘D_{T}’ is the total quantity of data stored in the database across all the database partitions.

After calculating the quantity of data to be stored on each database partition that yields the same response time from each database partition, identifying (500) a new partitioning of the database in dependence upon the database partition characteristics (306) may then be carried out by calculating the percentage of the new partition percent (508) for each database partition according the quantity of data to be stored on each database partition. Calculating the new partition percent (508) for each database partition according the quantity of data to be stored on each database partition may be carried out by dividing the quantity of data to be stored on each database partition by the total quantity of data stored in the database across all the database partitions. The new partition percent (508) for each database partition may therefore be calculated as follows:
P₁=D₁×D_{T}=133.33 megabytes÷300 megabytes=44.4% partition1
P₂=D₂×D_{T}=133.33 megabytes÷300 megabytes=44.4% partition2
P₃=D₃×D_{T}=33.33 megabytes÷300 megabytes=11.1% partition3

where ‘P_{N}’ is the new partition percent (508) for the N^{th} database partition, ‘D_{N}’ is the quantity of data returned from querying the N^{th} database partition, and ‘D_{T}’ is the total quantity of data stored in the database across all the database partitions.

In the example of FIG. 5, identifying (500) a new partitioning of the database in dependence upon the database partition characteristics (306) may also be carried out by storing the new partition percent (508) for each database partition in a new partition table (502). The new partition table (502) associates a partition identifier (408) with a new partition percent (508). The partition identifier (408) represents a database partition of the database. The new partition percent (508) represents the percentage of the total data stored in the database to be stored in a database partition identified by the partition identifier (408) and in dependence upon the database partition characteristics (306).

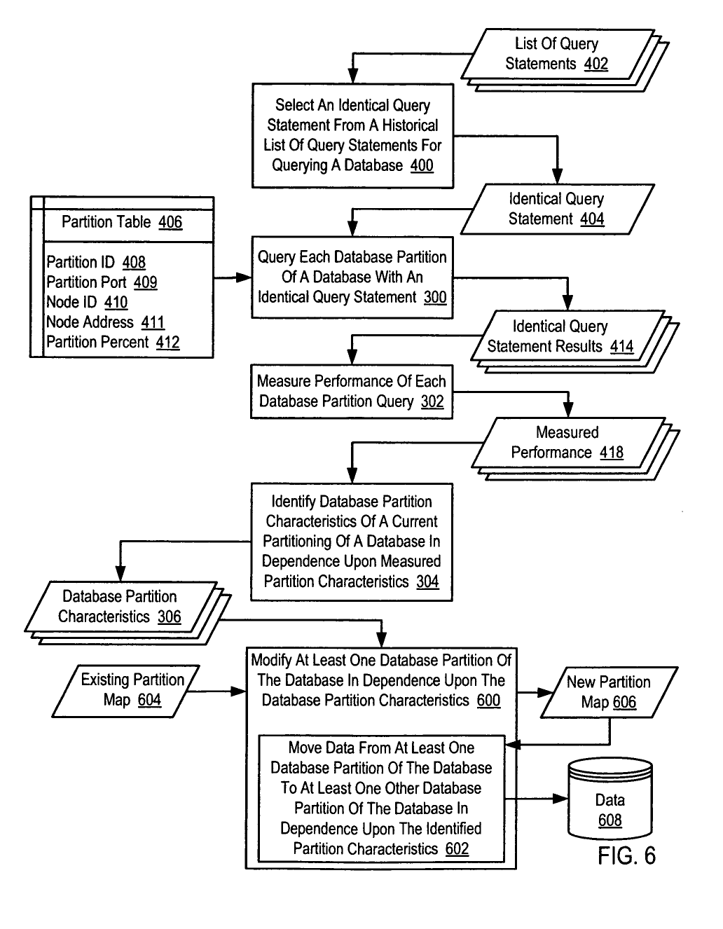

Readers will notice that the method set forth in FIG. 5 evaluates a current partitioning of a database by identifying a new partitioning of a database in dependence upon database partition characteristics. Evaluating a current partitioning of a database according to embodiments of the present invention may also operate to modify at least one database partition of the database in dependence upon the database partition characteristics. For further explanation, FIG. 6 sets forth a flow chart illustrating a further exemplary method for evaluating a current partitioning of a database according to embodiments of the present invention. The method of FIG. 6 includes selecting (400) the identical query statement (404) from a historical list of query statements (402) for querying the database, querying (300) each database partition of the database with an identical query statement (404), measuring (302) performance of each database partition query, identifying (304) database partition characteristics (306) of the current partitioning of the database in dependence upon the measured performance (418), and modifying (600) at least one database partition of the database in dependence upon the database partition characteristics (306).

The method of FIG. 6 begins with selecting (400) the identical query statement (404) from a historical list of query statements (402) for querying the database. The historical list of query statements (402) represents all results calculated by the database prior to selecting (400) the identical query statement. Selecting (400) the identical query statement (404) from a historical list of query statements (402) for querying the database may be carried out as described above with reference to FIG. 4.

The method of FIG. 6 includes querying (300) each database partition of the database with an identical query statement (404). The identical query statement (404) represents the result to be calculated by each database partition of a database for evaluating the current partitioning of the database. Querying (300) each database partition of the database with an identical query statement (404) according to the example of FIG. 6 may be carried out as described above with reference to FIG. 4 and storing the result (414) of each database partition query in computer memory.

The example of FIG. 6 also includes a partition table (406) that associates a partition identifier (408) with a partition port (409), a node identifier (410), a node address (411), and a partition percent (412). The partition identifier (408) represents a database partition resulting from the current partitioning of the database. The partition port (409) represents port address for the database manager that manages the database partition identified by the partition identifier (408). The node identifier (410) represents a computer node whose hardware resources are allocated to a database partition identified by the partition identifier (408). The node address (411) represents a network address on a network of the node identified by the node identifier (410). The partition percent (412) represents the percentage of the total data stored in the database that is stored in a database partition identified by the partition identifier (408).

The method of FIG. 6 includes measuring (302) performance of each database partition query. The measured performance (418) represents characteristics of querying a database partition of a database with an identical query statement (404). measuring (302) performance of each database partition query may be carried out as described above with reference to FIG. 4.

The method of FIG. 6 includes identifying (304) database partition characteristics (306) of the current partitioning of the database in dependence upon the measured performance (418). Database partition characteristics (306) represent characteristics of a database partition of a database. Identifying (304) database partition characteristics (306) of the current partitioning of the database in dependence upon the measured performance (418) may be carried out as described above with reference to FIG. 4.

The method of FIG. 6 also includes modifying (600) at least one database partition of the database in dependence upon the database partition characteristics (306). Modifying (600) at least one database partition of the database in dependence upon the database partition characteristics (306) according to the method of FIG. 6 may be carried out by replacing the existing partition map (604) of a database partition with a new partition map (606) for the database partition.

Readers will recall that a partition map stores the mapping between a particular value of a partitioning key and particular database partition. In a database utilizing hash partitioning the partition map consists of a fixed number of entries such as, for example, 512 entries, 1024 entries, 4096 entries, and so on. Each entry of the partition map contains a partition identifier that maps a particular entry to a particular database partition. Consider, for example, a partition map that contains 1024 entries ranging in number from 0 to 1023 and three database partitioned identified by partition identifiers ‘1,’ ‘2,’ and ‘3.’ The partition map entry numbered ‘0’ may contain a value for a partition identifier of ‘1,’ the partition map entry numbered ‘1’ may contain a value for a partition identifier of ‘2,’ the partition map entry numbered ‘2’ may contain a value for a partition identifier of ‘3,’ the partition map entry numbered ‘3’ may contain a value for a partition identifier of ‘1,’ the partition map entry numbered ‘4’ may contain a value for a partition identifier of ‘2,’ and so on, until all the partition map entries store a value for a partition identifier of either ‘1,’ ‘2,’ or ‘3.’

Distributing the partition identifiers using a round-robin algorithm as in the previous example typically yields an even distribution of the data across all the database partition of the database. Weighting the distribution of partition identifiers to include an unequal distribution of values for partition identifiers in the partition map may skew the distribution of the data across the database partitions of the database. Replacing the existing partition map (604) of a database partition with a new partition map (606) for the database partition may therefore provide the ability to skew the distribution of the data across the database partitions in dependence upon database partition characteristics (306) by distributing the partition identifiers in the entries of the new partition map (606) according to the new partitioning of the database identified in the method of FIG. 5. Continuing with the example from above, consider a new partitioning of the database where a database partition having a value of ‘1’ for the partition identifier will store 50% of the data in the database, a database partition having a value of ‘2’ for the partition identifier will store 30% of the data in the database, and a database partition having a value of ‘3’ for the partition identifier will store 20% of the data in the database. Using such a new partitioning of the database, 50% of the entries in the new partition map (606) store a value of ‘1,’ 30% of the entries in the new partition map (606) store a value of ‘2,’ and 20% of the entries in the new partition map (606) store a value of ‘3.’

In the method of FIG. 6, modifying (600) at least one database partition of the database in dependence upon the database partition characteristics (306) includes moving (602) data (608) from at least one database partition of the database to at least one other database partition of the database in dependence upon the database partition characteristics (306). Moving (602) data (608) from at least one database partition of the database to at least one other database partition of the database in dependence upon the database partition characteristics (306) may be carried out by redistributing data across the database partitions of a database in dependence upon the new partition map (606). Redistributing data across the database partitions of a database in dependence upon the new partition map (606) may be carried out using the ‘sqludrdt’ function in the IBM® DB2 Universal Database™.

Exemplary embodiments of the present invention are described largely in the context of a fully functional computer system for evaluating a current partitioning of a database. Readers of skill in the art will recognize, however, that the present invention also may be embodied in a computer program product disposed on signal bearing media for use with any suitable data processing system. Such signal bearing media may be transmission media or recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method for evaluating a current partitioning of a database, the method comprising:
querying each database partition of the database with an identical query statement;
measuring performance of each database partition query; and
identifying database partition characteristics of the current partitioning of the database in dependence upon the measured performance.

2. The method of claim 1 further comprising selecting the identical query statement from a historical list of query statements for querying the database.

3. The method of claim 1 further comprising identifying a new partitioning of the database in dependence upon the database partition characteristics.

4. The method of claim 1 further comprising modifying at least one database partition of the database in dependence upon the database partition characteristics.

5. The method of claim 4 wherein modifying at least one database partition of the database in dependence upon the database partition characteristics further comprises moving data from at least one database partition of the database to at least one other database partition of the database in dependence upon the database partition characteristics.

6. The method of claim 1 further comprising reporting the database partition characteristics.

7. The method of claim 1 wherein measuring the performance of each database partition query further comprises measuring the response time of each database partition query.

8. An apparatus for evaluating a current partitioning of a database, the apparatus comprising a computer processor, a computer memory operatively coupled to the computer processor, the computer memory having disposed within it computer program instructions capable of:
querying each database partition of the database with an identical query statement;
measuring performance of each database partition query; and
identifying database partition characteristics of the current partitioning of the database in dependence upon the measured performance.

9. The apparatus of claim 8 further comprising computer program instructions capable of selecting the identical query statement from a historical list of query statements for querying the database.

10. The apparatus of claim 8 further comprising computer program instructions capable of identifying a new partitioning of the database in dependence upon the database partition characteristics.

11. The apparatus of claim 8 further comprising computer program instructions capable of modifying at least one database partition of the database in dependence upon the database partition characteristics.

12. The apparatus of claim 11 wherein modifying at least one database partition of the database in dependence upon the database partition characteristics further comprises moving data from at least one database partition of the database to at least one other database partition of the database in dependence upon the database partition characteristics.

13. The apparatus of claim 8 wherein measuring the performance of each database partition query further comprises measuring the response time of each database partition query.

14. A computer program product for evaluating a current partitioning of a database, the computer program product disposed upon a signal bearing medium, the computer program product comprising computer program instructions capable of:
querying each database partition of the database with an identical query statement;
measuring performance of each database partition query; and
identifying database partition characteristics of the current partitioning of the database in dependence upon the measured performance.

15. The computer program product of claim 14 wherein the signal bearing medium comprises a recordable medium.

16. The computer program product of claim 14 wherein the signal bearing medium comprises a transmission medium.

17. The computer program product of claim 14 further comprising computer program instructions capable of identifying a new partitioning of the database in dependence upon the database partition characteristics.

18. The computer program product of claim 14 further comprising computer program instructions capable of modifying at least one database partition of the database in dependence upon the database partition characteristics.

19. The computer program product of claim 18 wherein modifying at least one database partition of the database in dependence upon the database partition characteristics further comprises moving data from at least one database partition of the database to at least one other database partition of the database in dependence upon the database partition characteristics.

20. The computer program product of claim 14 wherein measuring the performance of each database partition query further comprises measuring the response time of each database partition query.
